(19) United States
(12) Patent Application Publication
(10) Pub. No.: US 2015/0317760 A1
(43) Pub. Date: Nov. 5, 2015

(54) METHOD, APPARATUS, AND COMPUTER-READABLE MEDIUM FOR IDENTIFYING A CAREER PATH

(71) Applicant: Thomas Tam Tuong Pham, King of Prussia, PA (US)

(72) Inventor: Thomas Tam Tuong Pham, King of Prussia, PA (US)

(21) Appl. No.: 14/701,614

(22) Filed: May 1, 2015

Related U.S. Application Data
(60) Provisional application No. 61/987,438, filed on May 1, 2014.

(51) Int. Cl. G06Q 50/20; G06Q 10/10

(52) U.S. Cl. CPC G06Q 50/2057; G06Q 10/105

(57) ABSTRACT

An apparatus, computer-readable medium, and computer-implemented method for identifying a career path includes receiving, career-related information from a user, the career-related information including at least one of a career start point, a career end point, a career start location, and a career end location, selecting a plurality of career path records from a data store based at least in part on the career-related information received from the user, each of the plurality of career path records including a plurality of career points comprising a career path, grouping the plurality of career path records into career path clusters, each career path cluster corresponding to a unique career path, identifying a career path cluster in the career path clusters which contains the greatest number of career path records, the identified career path cluster having a corresponding career path, and transmitting information regarding the corresponding career path.

### RELATED APPLICATION DATA

This application claims priority to U.S. Provisional Application No. 61/987,438, filed May 1, 2014, the disclosure of which is hereby incorporated by reference in its entirety.

### BACKGROUND

The cost of higher education in the United States has increased almost one hundred and forty percent over the past 20 years (adjusted for inflation), according to the College Board. Some forecasters have projected the costs to continue increasing at the same or even greater rates. The average undergraduate student graduating in 2013 has a debt amount of greater than $35,000.

Unfortunately, there is seldom any guidance provided ahead of time regarding whether an investment in a particular college is worthwhile, necessary, or important for achieving a student's career goals. Additionally, there is no comprehensive method by which a potential student may determine the return on investment associated with the costs of attending a particular college or university.

There may be multiple paths to achieving the career or position that a person desires, but there is currently no way for an individual to compare their plan with other plans to determine if there are potentially better, faster, or more affordable options.

### BRIEF DESCRIPTION OF THE DRAWINGS

FIG. 1 illustrates a flowchart for identifying a career path according to an exemplary embodiment.

FIG. 2 illustrates a flowchart for generating a career path record according to an exemplary embodiment.

FIG. 3 illustrates an example of career path record generation according to an exemplary embodiment.

FIG. 4 illustrates a flowchart for selecting career path records from a data store according to an exemplary embodiment.

FIGS. 5A-5B illustrate an example process flow for identifying a career path according to an exemplary embodiment.

FIGS. 6-8 illustrate multiple versions of maps showing identified career paths according to an exemplary embodiment.

FIG. 9 illustrates a user interface for identifying a career path according to an exemplary embodiment.

FIG. 10 illustrates an exemplary computing environment that may be used to carry out the method for identifying a career path according to an exemplary embodiment.

### DETAILED DESCRIPTION

While methods, apparatuses, and computer-readable media are described herein by way of examples and embodiments, those skilled in the art recognize that methods, apparatuses, and computer-readable media for identifying a career path are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

There are no tools currently available to provide prospective students and other people with the information needed to make one of the most important decisions in their lives. For example, choosing the wrong major, college, or career path may have a life-long impact on a young person, as well as advisors to that person.

Relevant data is available. It resides in federal, state, and local government databases. It may be obtained from private and public universities. It may be gathered from private companies (for a price), or even crowd-sourced from a user base, or through a gamification interface to encourage user contribution. However the data is disparate and a mechanism has not yet be devise to consolidate, correlate, disseminate, and process the data in a meaningful and useful fashion for students, student-supporters, professionals and other individuals who are looking for career advice.

Applicant has discovered and developed new technology which allows users to identify and generate a career path for achieving a career-related goal by leveraging much of the career and biographical information that is available from various data sources.

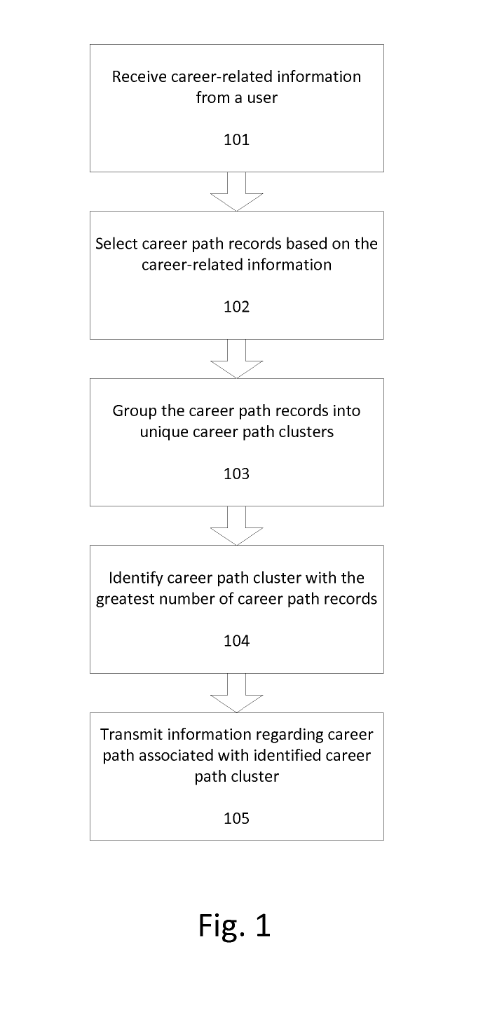

FIG. 1 is flowchart showing a method for identifying a career path according to an exemplary embodiment. At step 101, career-related input information is received from a user. The career-related input information may include a career start point, a career end point, a career start location, and/or a career end location. For example, the user may enter a career end-point of “software developer” and a city of San Jose, Calif.

At step 102, a plurality of career path records are selected from a data store based at least in part on the career-related input information received from the user. Each of these career path records includes a plurality of career points (each, a node) which comprise a career path.

Each career point may include a set of attributes and features, such as position, city, salary, costs, institution, company, etc. For example, a career point may be labelled as a position type, e.g., “Assistant Chef”, and include associated attribute data that describes the restaurant/company of employment, the city of employment, the years of employment, salary information (ranges, year-to-year fluctuations, market data, breakdown by sub-industry, growth in the sector, salary data by size of company, and the like), or any other information associated with the career point. Of course, career points are not limited to professional positions and may include any relevant biographical, skills, or employment related information, such as schools attended (with major as an attribute), internships, volunteer work, etc. Some examples of potential career points include Grade Schools, Middle Schools, High Schools, Trade Schools, Technical Schools, Community Colleges, 2 Year Colleges, 4 Year Colleges, Graduate Universities, Internships, Military Service, Self-Employment, Job Hiatus/Travel abroad, Community Service, Professions, Internship, Apprenticeship, Clerkship, Medical Residencies, MBA programs, Professional Certifications, Ongoing Adult Education, and/or Public Office. Career points may also incorporate additional data that is associated with the career point, such as for example, test scores. For example, a high school career point may have an associated SAT score or ACT score which is later used to filter career paths, or a four year college career point may have an associated MCAT, LSAT, or GRE score.

At step 103, the career path records may be generated as a plurality of career path clusters, with each career path cluster in the plurality of career path clusters corresponding to a unique career path. The clusters may be generated by determining, for each career path record, whether the career path record corresponds to a new career path. If the career path record corresponds to a new career path (i.e. one that has not been encountered before), then a new career path cluster may be generated corresponding to the new career path and the career path record may be added to the new career path cluster. If the career path record does not correspond to a new career path, this means that the career path record belongs in an existing career path cluster, and it is added to that existing cluster. The career path clusters can be represented in the memory of a computing device as a data structure. For example, a career path cluster can be stored in memory as a defined class object, a data structure, an array, a linked list, etc.

By way of non-limiting example, each of the career paths for each of the career path records may be compared to career paths associated with existing career path clusters. Based on the comparison, it may be determined whether a new cluster needs to be created for a particular career path record or, alternatively, which cluster should be added to a career path record in the event that an associated career path is not new.

At step 104 a career path cluster in the plurality of career path clusters which contains the greatest number of career path records may be identified as the “winning” cluster. This career path cluster represents the career path corresponding to the greatest number of people who match the career-related information provided by the user. By way of example only, if the user entered a career end point, then the identified winning cluster would correspond to the path that the greatest number of people had used to reach that career end point. Additionally, if the user entered a career end point and a career end location, then the identified winning cluster would correspond to the path that the greatest number of people had used to reach that career point in the location specified by the user.

At step 105, information regarding the career path associated with the identified career path cluster is transmitted. This information may be transmitted in the form of a model or a map showing each of the career points as virtual “locations” on the map. Additionally, the information may be transmitted in the form of a summary, a chart, a table, a spreadsheet, a graph, or any other visual representation that is to be appreciated by those skilled in the relevant art.

Additionally, one or more additional career path clusters in the plurality of career path clusters may be identified and information regarding one or more career paths corresponding to the one or more additional career path clusters may also be transmitted to a user. For example, all career paths that meet a predetermined percentage requirement (meaning the career path corresponds to at least a predetermined percentage of all the career path records matching the career related information in the data store) may be transmitted to a user. So, for example, if the predetermined percentage is 30%, then all career paths that constitute at least 30% of the total career paths matching the user provided career related information may be identified and displayed. As is to be appreciated by those skilled in the relevant art, a predetermined, user inputted, or dynamic percentage value may be utilized to generate correlations between the set of all career paths and user provided career related information such that either a very high level, for example, 95%, of correlation is shown or, conversely, a very low level, for example, 0.0001%, of correlation is shown.

Of course, career path records and their corresponding career paths may be selected for presentation to the user in other ways as well. For example, if there are insufficient career path records to make a determination regarding a most common career path for a particular piece of career-related information, then an estimate or probability determination may be made regarding the most-likely career path corresponding to that piece of career-related information. This may be based on analysis of career information that is similar or analogous to the provided career-related information. For example, a user may enter a career end point of “Endocrinologist” and a career end location of “Columbia, Mo.” If there are insufficient career path records to make a determination regarding a most commonly used career path for those career goals (for example, if there are only two career path records that include a career point of “Endocrinologist in Columbia, Missouri”), then similar career path records may be utilized to provide a probabilistic estimate of a “most-likely” career path. For example, career path records which include a career point of “Endocrinologist in St. Louis, Mo.” may be utilized in conjunction with the process described in FIG. 1. Similar career path records can include career path records having locations which are proximate to the provided career location (such as within a predefined or user-input distance) or which are similar in nature to the provided career point (where similarity can be defined by the user, a third party source, an dichotomy or glossary of careers, or any other information source).

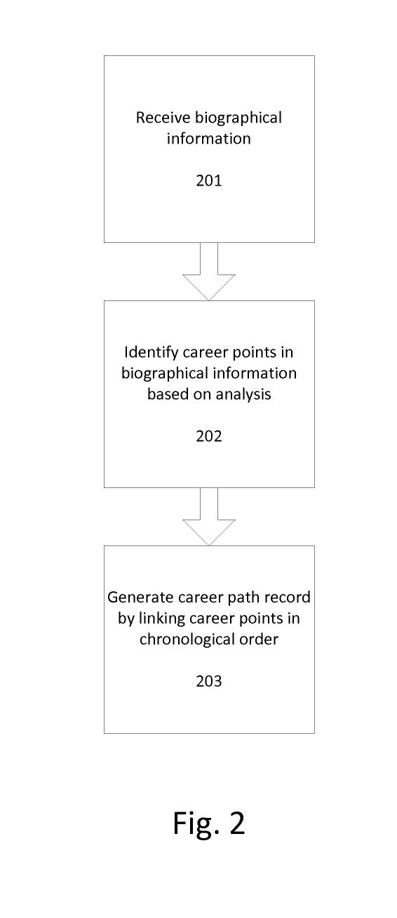

Turning to FIG. 2, a flowchart for a method of generating career path records is shown according to an exemplary embodiment. At step 201 biographical information is received from one or more data sources. The biographical information does not have to include the identity of a particular person and may be anonymous, but does include information relating to career points of the person, as well as any associated information or attributes for each career point.

Information may be collected from a variety of data sources. Institutional and government statistics information may be pulled from relevant databases and website, using APIs, screen scraping or other methods in the art as may be appropriate. For example, web pages of companies and institutions of higher education can be automatically data mined to gather information. Sources may include public access labor and educational organizations such as the Bureau of Labor Statistics, United States Census, Public Universities, and local and state governments. The information may also include private institutional data such as graduation rates and majors from private and liberal arts universities, as well as other statistical data relating to percentage of graduates employed in the field of their study after a defined time period post-graduation, or salaries, or locations, or enrollment in further education, etc. Further private database sources may also be utilized, including, but not limited to, social networks such as LinkedIn, Facebook or other sources that provide relevant data points from which to generate models or nodes or clusters.

User submitted data may be incorporated into system. For example, users may register with the system and provide their own biographical information. This biographical information may be optionally anonymized and incorporated into the data store as a career path record. Automated approaches may also be used to extract the relevant data from information provided by a user. For example, a user may upload a resume and their career points may be extracted from the resume using natural language processing techniques and used to generate and store a career path record. User submitted resumes may be combined into one or more databases for generating career point data for other users. Further, resumes that are on publically available websites may be manually or automatically imported using the same techniques. In such a case, resumes manually or automatically imported from third-party sources, which may not have reliable data, may be provided a weighted score that reflects the reliability of the source material. Indeed, each data set used for generating career points may be assigned a weighted score that is used to indicate a reliability quotient or other indicator as to the import of the source material.

In addition, third party mined data and private company data may also collected and used to generate and store career path records. For example, employment data may be collected from Staffing and Recruitment companies, social media companies, and other private businesses.

Returning to FIG. 2, at step 202 a plurality of career points in the biographical information are identified based on an analysis of the biographical information. This may be a textual analysis and may be performed using natural language processing techniques. For example, entity recognition/entity extraction may be used to determine when a potential career point is mentioned in the text, such as the mention of a known educational institution. Additionally, features and attributes corresponding to a potential career points may be extracted based on an analysis of proximity to the potential career point and/or structure of the text in a particular document. Additionally, the received information may be pre-formatted in some way and pre-existing knowledge of the information source may be used to identify a career point. For example, a set of database records may be received from a University including names of graduates and majors. In this situation, all of those persons will have a career point corresponding to that University and the task of identifying a “major” attribute involves a simple mapping operation.

At step 203, a career path record is generated by linking the plurality of career points corresponding to a particular person in chronological order. The temporal information corresponding to each career point may be received and extracted as described in steps 201 and 202 described above. In the event that the temporal information is unavailable or not readily ascertained, one or more algorithms may be used to determine an estimate or best guess regarding the order of the career points. For example, if a person's career points included a four year university and a professional occupation ordinarily held by those with university degrees, the four-year university may be assumed to occur prior to the professional occupation. Optionally, the career points may be linked in a non-chronological order, such as if chronological information is unavailable or not desired. Career points may be organized as an ordered set, wherein a “traditional” order of operation is assumed, e.g., grade school before high school before college, while at the same time internships, before graduate school, while at the same time clinical study, before professional position end-point.

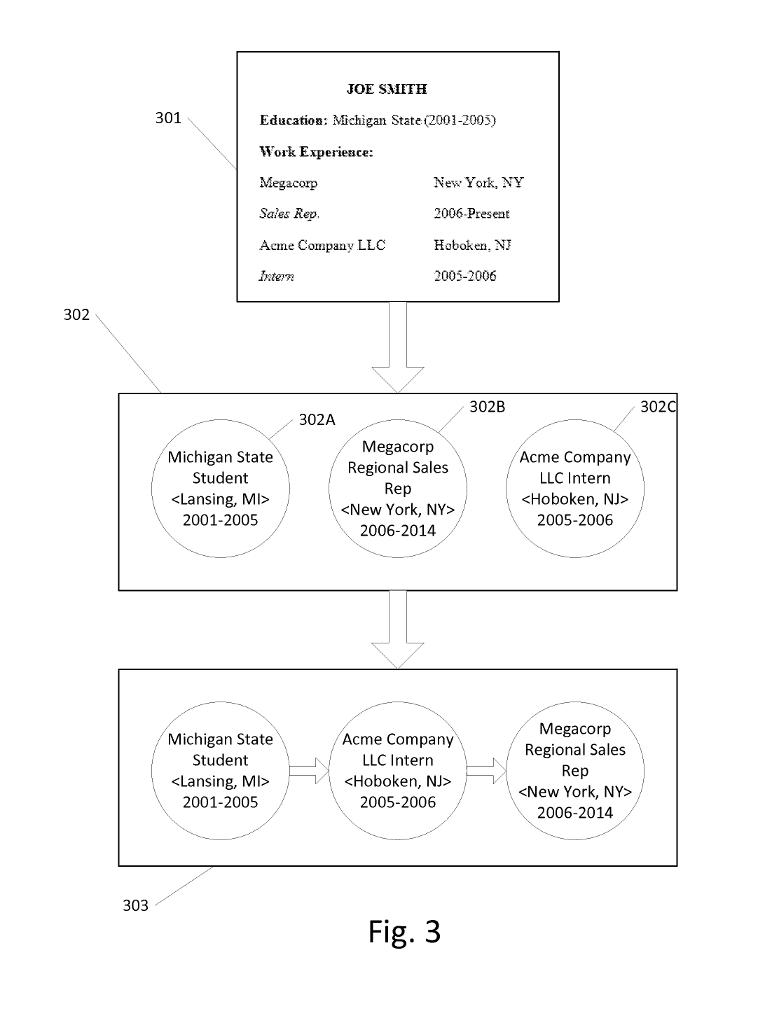

FIG. 3 illustrates an example of the career path record generation process. Received information 301 corresponds to a resume for person “Joe Smith” and includes educational and work experience of Joe Smith. As shown at 302, three career points, 302A, 302B, and 303C may be extracted from the received information 301. These career points and associated attributed may be extracted using the techniques described earlier. For example, a resume template may be used to identify the time period associated with each potential career point in a resume and the time period may then be incorporated into the career point.

Diagram 303 illustrates a career path record for Joe Smith including each of the three career points 302A, 302B, and 302C. As shown in 303, the career points are linked in chronological order. The career path record may then be stored in the data store in any suitable format. For example, each career path record may be defined as an array or linked list of career points, or each career path record may be an independent object which incorporates each of the career points into the object. Many variations are possible and these examples are not intended to be limiting. In another example, each career path record can be defined as a sequence of objects in a graph database, where each of the objects corresponds to a career point and the chronological sequence between the career points is represented as the links in the graph database.

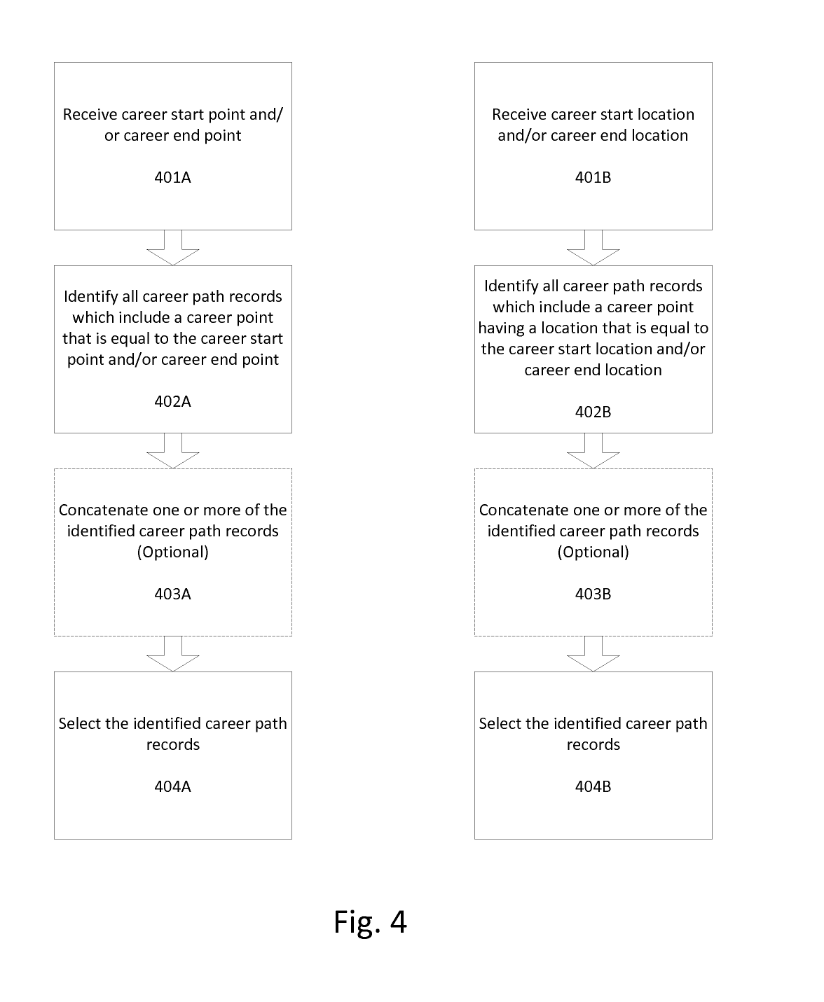

Turning to FIG. 4, flowcharts for methods of selecting career path records from a data store are shown according to an exemplary embodiment. At step 401A a career start point and/or a career end point is received. At step 401B all career path records which include a career point that is equal to the career start point and/or career end point are identified. For example, if a user entered a career end point of “Lawyer” and a career path record for a person included the career point “Lawyer,” that career path record would be identified.

At step 403A, one or more of the identified career path records may optionally be concatenated based on a position of the career start point and/or the career end point in the identified career path record.

This is useful in the scenario where an entered career end point matches some career point in a career path record, but the matching career point is not the endpoint of the career path record. For example, using the earlier example of someone who entered “Lawyer,” an identified career path record may be: Undergraduate Student→Law Student→Lawyer→Judge. In this case, the “Judge” career point is not necessary and may be omitted, resulting in a concatenated career path record of Undergraduate Student→Law Student→Lawyer. A similar rule may be used for career start points. For example, if a user listed “Law Student” as a career start point, then the “Undergraduate Student” may be omitted. Further, a career path record may include branching events, wherein a node bifurcates to a plurality of paths, each of which provides a different (yet, potentially related) career end point.

At step 404A, the identified career path records (including any potentially concatenated career path records) are selected and used to identify a career path as described in FIG. 1.

In addition to, or as an alternative to the career start point and career end point, users may provide a career start location and/or career end location, as shown at step 401B. At step 402B all career path records which include a career point having a career point location that is equal to the career start point and/or career end point are identified. At step 403B, one or more of the identified career path records may optionally be concatenated based on a position of the career point which has an associated career point location corresponding to at least one of the career start point and the career end point. This is similar to concatenation described with regard to step 403A. For example, if a user provides a career end point of Des Moines, Iowa, and an identified career path record includes locations corresponding to career points: New York→Chicago→Des Moines→Los Angeles, then the career point corresponding to the Los Angeles location may be omitted.

At step 404B, the identified career path records (including any potentially concatenated career path records) are selected and used to identify a career path as described in FIG. 1. If a user provides both location information and career point information, then both the processes performed by steps 401A-401A and 401B-401B may be performed. For example, the processes may be performed concurrently to generate two sets of identified career path records. After this, the career path records which occur in both sets may be selected for analysis according to the method described with reference to FIG. 1.

Many variations of career-related information may be provided by the user. The table below illustrates some of the combinations of information that may be provided relating to career start point, career end point, career start location, and career end location and corresponding example results:

| | | City/State | City/State | |
|---|---|---|---|---|
| Career | Career | Start | End | |
| Start Point | End Point | Location | Location | |
| Entered | Entered | Entered | Entered | Output and Example Use Case |
| Yes | Yes | Yes | Yes | Generate most commonly used path |
| | | | | to end point from specified start |
| | | | | city/state to end city/state; presented |
| | | | | in the form of a model or map. |
| | | | | e.g. Student from Lower Merion, |
| | | | | PA wants to know how to become a |
| | | | | doctor in New York City, NY |
| Yes | Yes | Yes | No | Generate most common path to |
| | | | | specified profession from specified |
| | | | | City/State; presented in the form of |
| | | | | a model or map. |
| | | | | E.g. Student from Lower Merion, |
| | | | | PA wants to become a Medical |
| | | | | Doctor anywhere. |
| Yes | Yes | No | No | Generate most common used |
| | | | | path(s) in USA to specified Career |
| | | | | End Point and the most common |
| | | | | City/State for that career choice; |
| | | | | presented in the form of a model or |
| | | | | map. |
| | | | | E.g. IT Programmer wants to |
| | | | | become a television actor. |
| Yes | No | No | No | Generate most common path taken |
| | | | | to the most common profession(s) |
| | | | | in the USA; presented in the form |
| | | | | of a model or map. |
| | | | | E.g. Student from anywhere in USA |
| | | | | wants to know what everyone else |
| | | | | is doing and where they are doing it. |
| Yes | No | Yes | Yes | Generate most commonly used |
| | | | | path(s) and most common |
| | | | | profession(s) from and to specified |
| | | | | cities/states; presented in the form |
| | | | | of a model or map. |
| | | | | E.g. Student from Lower Merion, |
| | | | | PA wants to work in NYC but is |
| | | | | uncertain of what he wants to be. |
| Yes | No | No | Yes | Generate most common path(s) and |
| | | | | most common profession(s) to |
| | | | | specific city/state; presented in the |
| | | | | form of a model or map. |
| | | | | E.g. Student from anywhere in USA |
| | | | | wants to know the types of jobs |
| | | | | available in NYC but doesn't know |
| | | | | what he wants to do. |
| Yes | No | Yes | No | Generate most common path(s) and |
| | | | | profession(s) from specified start |
| | | | | point; presented in the form of a |
| | | | | model or map. |
| | | | | E.g. Student from Lower Merion, |
| | | | | PA does not know what he wants to |
| | | | | do after high school. Results will |
| | | | | provide most common map used by |
| | | | | students from that High School. |
| No | Yes | Yes | Yes | Generate most common path(s) to |
| | | | | specified profession(s) in specified |
| | | | | City/State; presented in the form of |
| | | | | a model or map. |
| | | | | E.g. HR recruiter is interested in |
| | | | | knowing paths career paths taken |
| | | | | from individuals from Philadelphia |
| | | | | and who are currently working |
| | | | | NYC. |
| No | No | Yes | Yes | Generate most common path(s) and |
| | | | | most common profession(s) from |
| | | | | individuals starting from specified |
| | | | | start city/state to specified end |
| | | | | city/state; presented in the form of a |
| | | | | model or map. |
| | | | | E.g. Sales Manager is interested in |
| | | | | know who is working in NYC and |
| | | | | also studied or working in |
| | | | | Philadelphia. |
| No | No | No | Yes | Generate most common path(s) |
| | | | | taken and most common |
| | | | | profession(s) in specified end |
| | | | | city/state; presented in the form of a |
| | | | | model or map. |
| | | | | E.g. Municipal office is interested |
| | | | | in supplementing there census data |
| | | | | with migration data to their |
| | | | | community. |
| No | Yes | No | No | Generate most common path(s) to |
| | | | | specified profession(s); presented in |
| | | | | the form of a model or map. |
| | | | | E.g. High school sophomore is |
| | | | | interested in becoming an astronaut. |
| No | Yes | No | Yes | Generate most common path(s) to |
| | | | | specified profession(s) in city/state; |
| | | | | presented in the form of a model or |
| | | | | map. |
| | | | | E.g. IT hiring manager wants to |
| | | | | compare potential maydidate career |
| | | | | path to those in same city. |
| No | Yes | Yes | No | Generate most common path(s) to |
| | | | | specified profession(s) from |
| | | | | specified city/state. |
| | | | | E.g. IT hiring manager wants to |
| | | | | compare all maydidates who started |
| | | | | their education in Pennsylvania. |

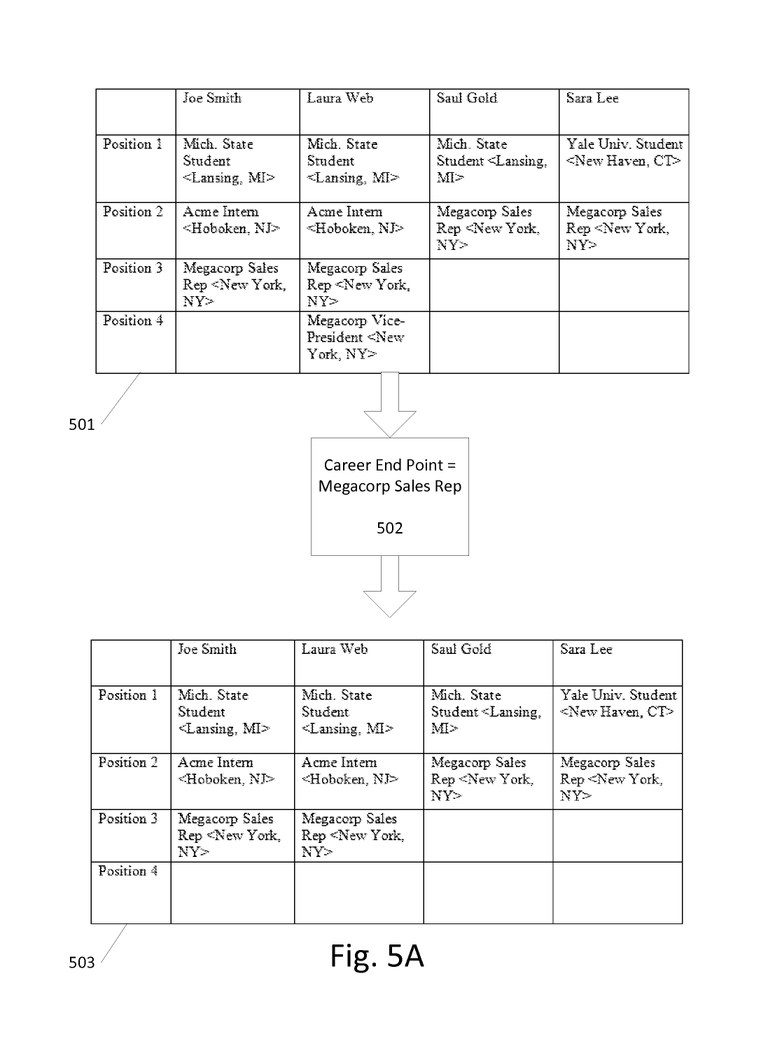

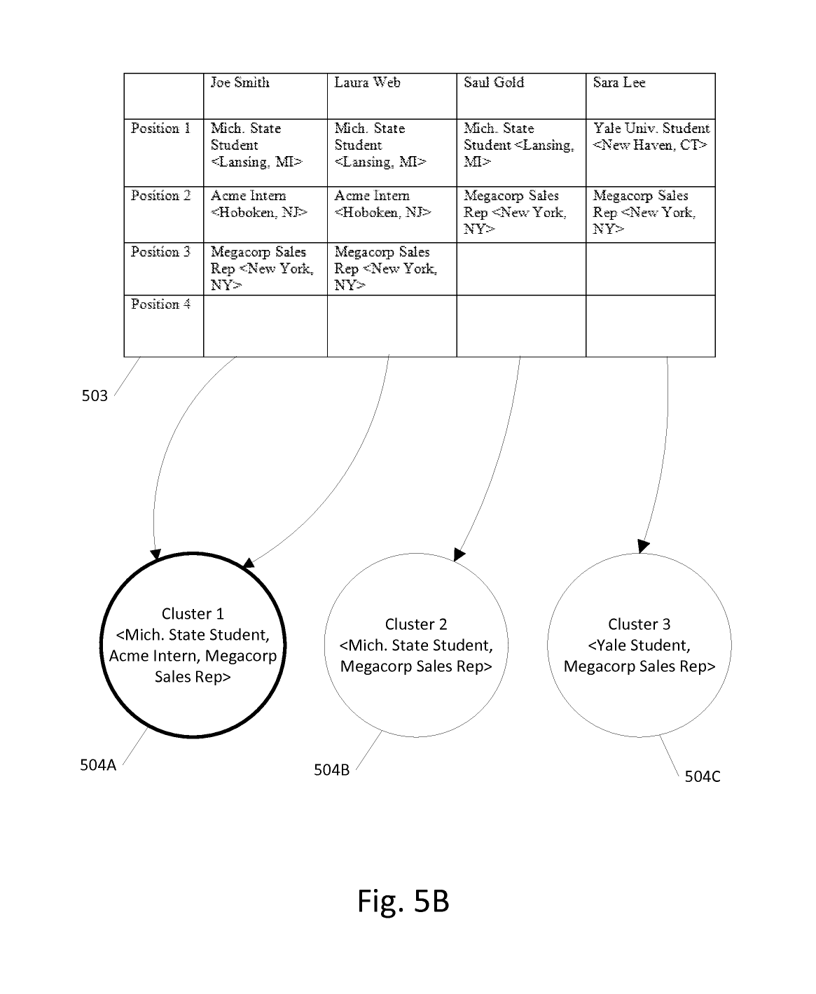

Turning to FIGS. 5A-5B, an example of the method for identifying a career path is shown using sample data. FIG. 5A shows an example data store 501 containing four career path records corresponding to persons Joe Smith, Laura Web, Saul Gold, and Sara Lee. At step 502, a user enters a career end point of “Megacorp Sales Rep.”

Based on the foregoing, all of the records in the data store 501 are identified, and a temporary data set is 503 created containing the relevant career path records. In the temporary data set 503 the career path record for Laura Web is concatenated because her career point of “Megacorp Vice President” occurred after the user provided career end point of “Megacorps Sales Rep.”

Turning to FIG. 5B, the career path records in the temporary data set 503 are then grouped into clusters according to the career path correspond to each career path record. For example, assuming that the career path records are processed left-to-right, the career path record for Joe Smith would be processed first. Since this is the first career path record and no clusters exist, then a new cluster is created 504A correspond to Joe Smith's career path.

The next career path record corresponding to Laura Web may be added to cluster 504A as well, since Laura Web's career path matches the career path corresponding to cluster 504A. The addition of a career path record may be performed in many ways. For example, a dynamic array corresponding to the cluster and which comprises all of the career path records may have an additional career path record added to it. Alternatively, a simple counter associated with a particular cluster may be incremented to indicate that another career path record has been added.

The career path records for Saul Gold and Sara Lee are used to create career path clusters 504B and 504C, respectively. This is because no existing career path clusters have career paths corresponding to those of Saul Gold or Sara Lee.

The result is that the first cluster 504A has two associated career path records while clusters 504B and 504C each have one. Therefore, information indicating that the path associated with the first cluster 504A is the most commonly used path to the career end point “Megacorp Sales Rep” may be transmitted to a user.

FIG. 5B illustrates a grouping of career paths based solely on positions, but other metrics associated with the career points in each career path may be used as well. For example, the grouping process may take into account time spent at each position (rounded off to some point such as months or years) so that only career paths which have the same order of positions and time at each position are grouped together in a cluster. For example, if a first career path had a first position which a person held for 5 years and a second career path had the same first position which a second person held for 3 years, those two career paths would be grouped into separate clusters, even if all of the career points in both of the career paths were otherwise identical.

Similarly, other metrics associated with the career points may be used to group the career paths into clusters. For example, if test scores are associated with a career point in the career path, then the test scores may also be used to group the career paths into clusters. So if two career paths had the same high school as a career point, but for one of the career paths the SAT score associated with the high school career point was in the 2201-2400 range and for the other career path the SAT score associated with the high school career point was in the 2001-2200 range, then the career paths may be grouped into separate clusters. As is to be appreciated by those of skill in the relevant art, any of the metrics associated with any of the possible career points may be used to differentiate between and group career paths into clusters.

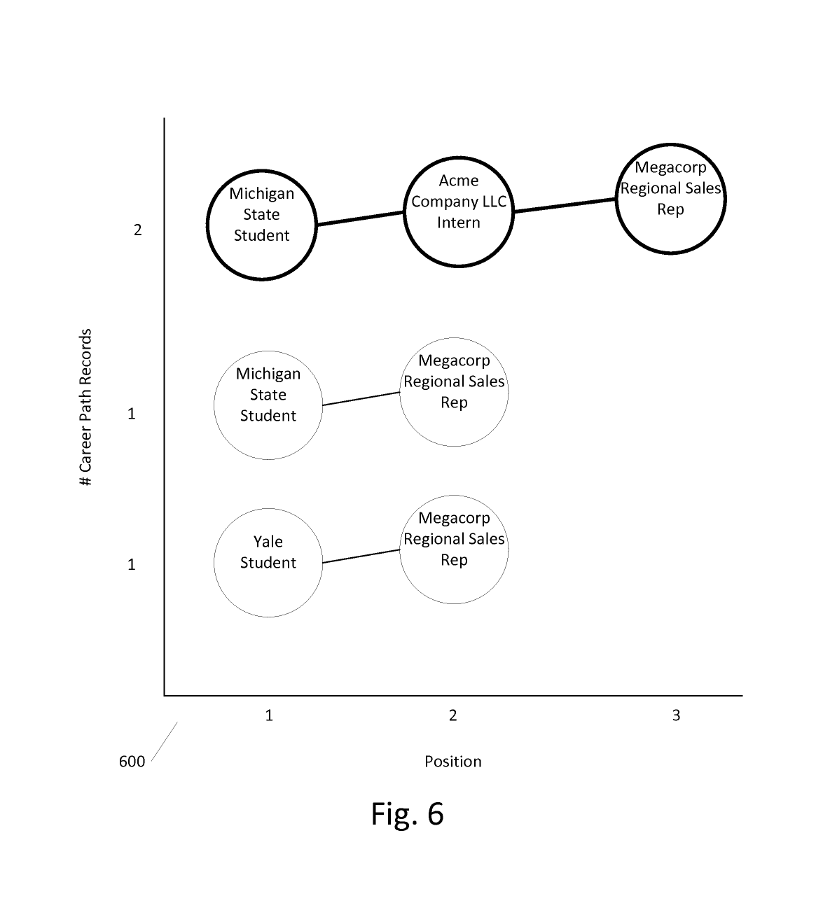

FIG. 6 illustrates one example output of the method based on the sample data provided in FIGS. 5A-5B. The transmitted data includes a map 600 with career paths corresponding to each of the career path clusters, including the most commonly used career path at the top in bold. As shown, the Y axis is used to represent the number of career path records in the cluster and the X axis represents the position of each career point.

This example is provided for illustration only and many variations are possible. For example, a third dimension may be used to represent costs associated with each career path, or costs associated with each career point within a career path. Additionally, time and financial costs associated with each career path may be aggregated and represented on one of the dimensions of the map.

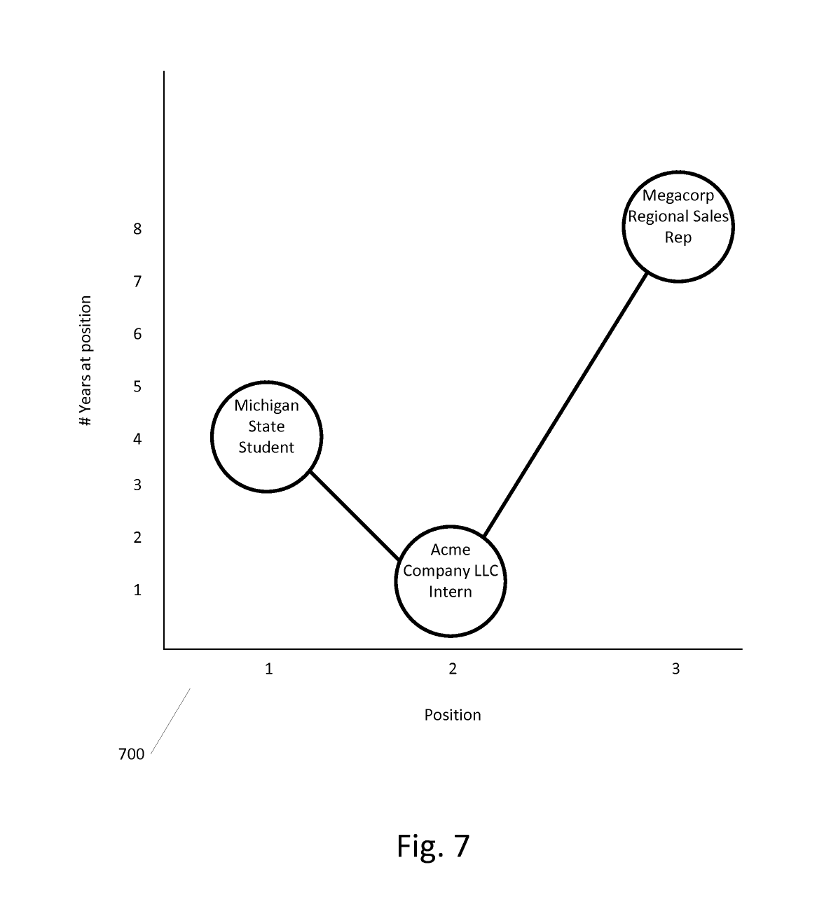

The time at each career point may also be represented on the map, such as on the Y-axis. FIG. 7 illustrates a map 700 showing an example of this with the career path record corresponding to “Joe Smith.” As shown in the map, the first career point at Michigan State lasted 4 years, the second career point at Acme lasted 1 year, and the third at Megacorp has lasted 8 years. The map 700 is shown with only a single career path record for the purpose of clarity, but it is understood that multiple career path records may be displayed on the map.

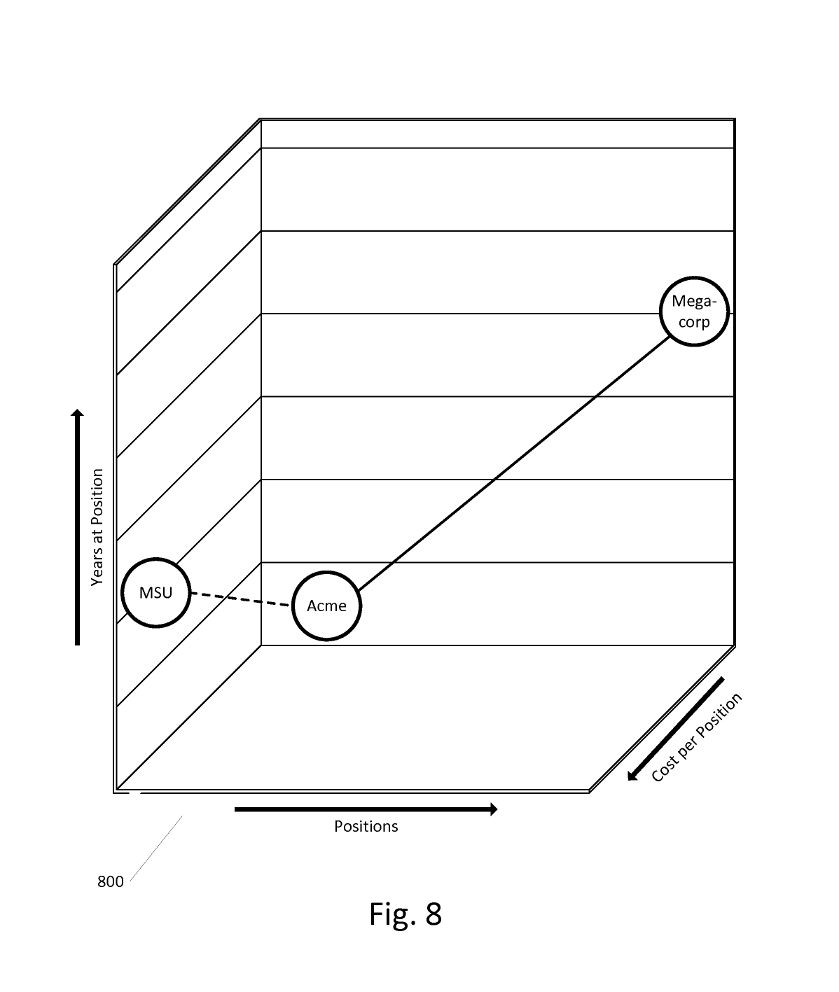

FIG. 8 illustrates a three-dimensional map 800 in which the cost per position has been added as the Z axis to map 700 of FIG. 7, with cost decreasing as depth increases. As the career point corresponding to Michigan State University is the only one which has an associated cost (assuming both the intern position at Acme and the Regional Sales Rep position at Megacorp do not cost money), the career point for Michigan State has the lowest z value and the dashed line to the next career point for Acme indicates an increase in depth (decrease in cost).

Of course, this map is provided as an example only, and many variations of transmitting or displaying career path information are possible. For example, the z-axis may be used to represent cost per path and may take into account any income received at career points in the career path. This may be useful to users in valuing potential returns on investments, such as for higher education.

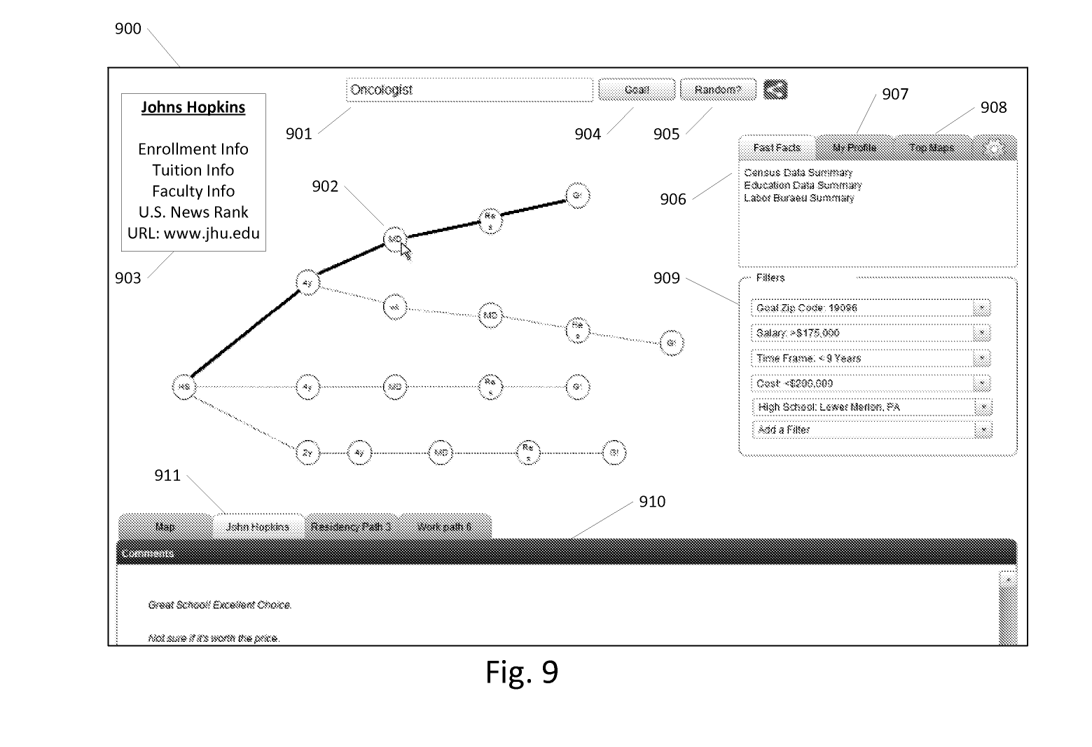

FIG. 9 illustrates a user interface 900 for the method for identifying a career path according to an exemplary embodiment. Interface 900 may include a search box 901 where user may enter career-related information, such as a career end point of “Oncologist” as shown, and select a search button 904. The resulting commonly used career paths 902 are displayed in the interface.

Each of the career points in the career paths 902 may be selectable and may provide additional information when selected by a user. For example, the user in interface 900 has moused over a career point corresponding to a medical degree (“MD”) at Johns Hopkins. As a result, an information window 903 corresponding to Johns Hopkins may be displayed and may include any potentially useful information, such as enrollment information, tuition information, faculty information, U.S. News rank, and/or URL. Additionally, if the career paths are clustered based on additional information associated with a particular career point, then that additional information may be displayed or transmitted to the user. For example, the average test scores (or range of test scores) at a particular career point in a career path may be displayed when that career point is highlighted or selected.

Interface also includes a random button 905 which may generate commonly used career paths corresponding to one or more random career end points, such as random professions. Also shown in interface 900 is a fast facts tab 906 which provides user access to underlying data sources and additional information used in the generation of the career paths, a profile tab 907 which allows a user to customize their setting or preferences, and a top maps tab 908 which allows a user to view the most commonly viewed career path maps.

Additionally, users may comment on the maps of other users or on specific career points, as is shown at 911. These comments may then be presented in any relevant maps which contain the career point. For example, each of the tabs in comment interface 910 corresponds to a different career point, such that comments are organized by career points.

User may also utilize one or more filters 909 to additionally filter the resulting commonly used career paths. Filters may include career end zip codes, salaries, time frames, costs, or starting schools, or any other relevant information which may be used to filter and select career paths. For example, after performing an initial search for a commonly used path to becoming an oncologist as shown in FIG. 9, a user may wish to further filter by four-year colleges and may select a specific four year college that they plan to attend. The resulting commonly used career paths may then be updated to reflect the new information and include only career paths which include a career point at the selected four year college.

Other features that may be available to users include editing of career paths in the map interface, refining results by way of filters, sharing generated maps through social media links, email, or other forms of communication, and saving maps for future reference. Users may also provide feedback on maps and generated career paths which may be incorporated into future updates.

The path generation and visualization techniques described herein may be applied to a variety of areas, not just potential career paths. For example, a person seeking to immigrate to the United States may search for immigration paths to obtain permanent resident status. The points in this path may include degrees (such as the type of degree and area), visas applied for and obtained, prior work experience, sponsoring organization, any countries previously immigrated to, and any other biographical information of persons who obtained permanent resident status. For example, a possible immigration path could be: B.S. (Computer Science)→Engineer (Tech Company, 5 years)→Mayadian Visa Holder→U.S. H-1B Visa Holder→U.S. Permanent Resident. A user may also filter the data to determine the best immigration path for a person with a particular background, degree, or country of residence. Additionally, the system may also be used to determine the most common or probable path used to apply for a visa in a particular country. Further examples include professional athlete paths, amateur athlete paths, exercise or weight loss regimens, scholarship paths, authorship paths, etc.

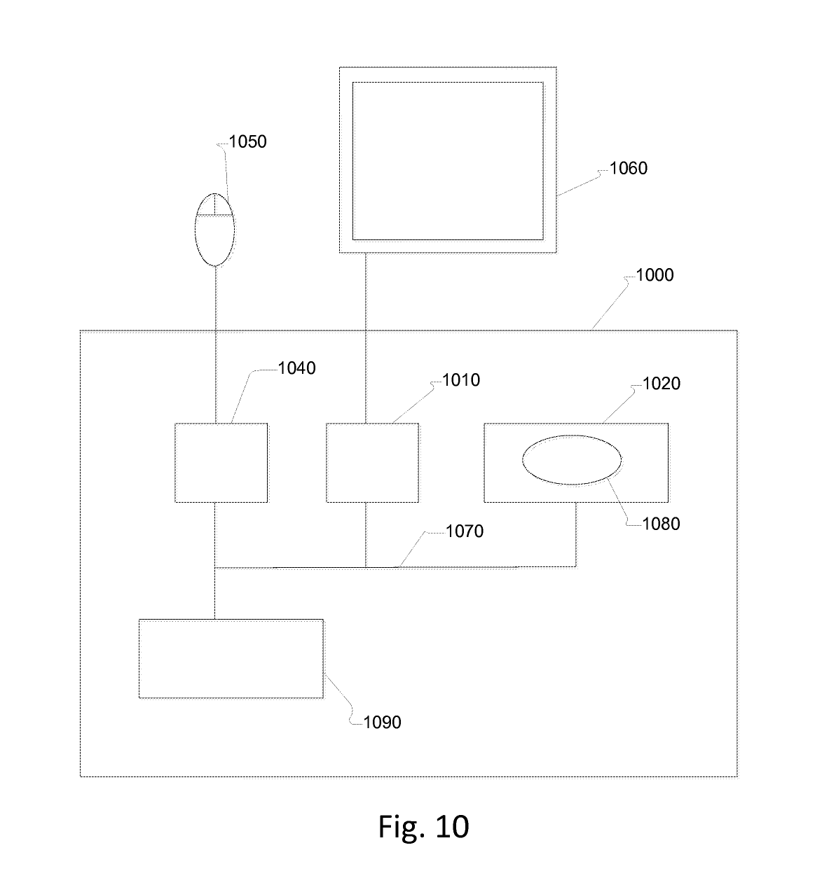

One or more of the above-described techniques may be implemented in or involve one or more computer systems. FIG. 10 illustrates a generalized example of a computing environment 1000. The computing environment 1000 is not intended to suggest any limitation as to scope of use or functionality of a described embodiment.

With reference to FIG. 10, the computing environment 1000 includes at least one processing unit 1010 and memory 1020. The processing unit 1010 executes computer-executable instructions and may be a real or a virtual processor. In a multi-processing system, multiple processing units execute computer-executable instructions to increase processing power. The memory 1020 may be volatile memory (e.g., registers, cache, RAM), non-volatile memory (e.g., ROM, EEPROM, flash memory, etc.), or some combination of the two. The memory 1020 may store software instructions 1080 for implementing the described techniques when executed by one or more processors. Memory 1020 may be one memory device or multiple memory devices.

A computing environment may have additional features. For example, the computing environment 1000 includes storage 1040, one or more input devices 1050, one or more output devices 1060, and one or more communication connections 1090. An interconnection mechanism 10100, such as a bus, controller, or network interconnects the components of the computing environment 1000. Typically, operating system software or firmware (not shown) provides an operating environment for other software executing in the computing environment 1000, and coordinates activities of the components of the computing environment 1000.

The storage 1040 may be removable or non-removable, and includes magnetic disks, magnetic tapes or cassettes, CD-ROMs, CD-RWs, DVDs, or any other medium which may be used to store information and which may be accessed within the computing environment 1000. The storage 1040 may store instructions for the software 1080.

The input device(s) 1050 may be a touch input device such as a keyboard, mouse, pen, trackball, touch screen, or game controller, a voice input device, a smayning device, a digital camera, remote control, or another device that provides input to the computing environment 1000. The output device(s) 1060 may be a display, television, monitor, printer, speaker, or another device that provides output from the computing environment 1000.

The communication connection(s) 1090 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations may be described in the general context of computer-readable media. Computer-readable media are any available media that may be accessed within a computing environment. By way of example, and not limitation, within the computing environment 1000, computer-readable media include memory 1020, storage 1040, communication media, and combinations of any of the above.

Of course, FIG. 10 illustrates computing environment 1000, display device 1060, and input device 1050 as separate devices for ease of identification only. Computing environment 1000, display device 1060, and input device 1050 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 1000 may be a set-top box, mobile device, personal computer, or one or more servers, for example a farm of networked servers, a clustered server environment, or a cloud network of computing devices.

Having described and illustrated the principles of our invention with reference to the described embodiment, it will be recognized that the described embodiment may be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiment shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. A method executed by one or more computing devices for identifying a career path, the method comprising:
receiving, by at least one of the one or more computing devices, career-related information from a user, the career-related information comprising at least one of a career start point, a career end point, a career start location, and a career end location;
selecting, by at least one of the one or more computing devices, a plurality of career path records based at least in part on the career-related information received from the user, wherein each of the plurality of career path records includes a plurality of career points comprising a career path;
grouping, by at least one of the one or more computing devices, the plurality of career path records into a plurality of career path clusters, wherein each career path cluster in the plurality of career path clusters corresponds to a unique career path;
identifying, by at least one of the one or more computing devices, a career path cluster in the plurality of career path clusters which contains the greatest number of career path records, the identified career path cluster having a corresponding career path; and
transmitting, by at least one of the one or more computing devices, information regarding the corresponding career path.

2. The method of claim 1, wherein at least one career path record in the plurality of career path records is generated by:
receiving biographical information from one or more data sources;
identifying a plurality of career points in the biographical information based on an analysis of the biographical information; and
generating a career path record by linking the plurality of career points in chronological order.

3. The method of claim 2, wherein the one or more data sources comprise at least one of institutional data, government collected data, user submitted data, and third party data.

4. The method of claim 1, wherein the career-related information comprises at least one of the career start point and the career end point and wherein selecting a plurality of career path records comprises:
identifying all career path records in a data store which include a career point that is equal to at least one of the career start point and the career end point; and
selecting the identified career path records.

5. The method of claim 4, wherein selecting the identified career path records comprises:
concatenating an identified career path record in the identified career path records based on a position of at least one of the career start point and the career end point in the identified career path record.

6. The method of claim 1, wherein the career-related information comprises at least one of a career start location and a career end location and wherein selecting a plurality of career path records comprises:
identifying all career path records in a data store which include a career point having an associated career point location which is equal to at least one of the career start location and the career end location; and
selecting the identified career path records.

7. The method of claim 6, wherein selecting the identified career path records comprises:
concatenating an identified career path record in the identified career path records based on a position of at least one career point which has an associated career point location corresponding to at least one of the career start point and the career end point.

8. The method of claim 1, wherein grouping the plurality of career path records comprises, for each career path record in the plurality of career path records:
determining whether the career path record corresponds to new career path;
generating a new career path cluster based at least in part on a determination that the career path record corresponds to a new career path, wherein the career path record is added to the new career path cluster; and
adding the career path record to an existing career path cluster based at least in part on a determination that the career path record does not correspond to a new career path.

9. The method of claim 8, where determining whether the career path record corresponds to new career path comprises:
comparing a career path associated with the career path record to one or more career paths associated with one or more existing career path clusters.

10. The method of claim 1, further comprising:
identifying, by at least one of the one or more computing devices, one or more additional career path clusters in the plurality of career path clusters, the one or more additional identified career path clusters having one or more corresponding career paths; and
transmitting, by at least one of the one or more computing devices, information regarding the one or more corresponding career paths.

11. A system for identifying a career path, said system comprising:
one or more processors; and
one or more memories operatively coupled to at least one of the one or more processors and having instructions stored thereon that, when executed by at least one of the one or more processors, cause at least one of the one or more processors to:
receive career-related information from a user, the career-related information comprising at least one of a career start point, a career end point, a career start location, and a career end location;
select a plurality of career path records based at least in part on the career-related information received from the user, wherein each of the plurality of career path records includes a plurality of career points comprising a career path;
group the plurality of career path records into a plurality of career path clusters, wherein each career path cluster in the plurality of career path clusters corresponds to a unique career path;
identify a career path cluster in the plurality of career path clusters which contains the greatest number of career path records, the identified career path cluster having a corresponding career path; and
transmit information regarding the corresponding career path.

12. The system of claim 11, wherein at least one career path record in the plurality of career path records is generated by:
receiving biographical information from one or more data sources;
identifying a plurality of career points in the biographical information based on an analysis of the biographical information; and
generating a career path record by linking the plurality of career points in chronological order.

13. The system of claim 11, wherein the career-related information comprises at least one of the career start point and the career end point and wherein the instructions that, when executed by at least one of the one or more processors, cause at least one of the one or more processors to select a plurality of career path records further cause at least one of the one or more processors to:
identify career path records in a data store which include a career point that is equal to at least one of the career start point and the career end point; and
select the identified career path records.

14. The system of claim 11, wherein the career-related information comprises at least one of a career start location and a career end location and wherein the instructions that, when executed by at least one of the one or more processors, cause at least one of the one or more processors to select a plurality of career path records further cause at least one of the one or more processors to:
identify all career path records in a data store which include a career point having an associated career point location which is equal to at least one of the career start location and the career end location; and
select the identified career path records.

15. The system of claim 11, wherein the instructions that, when executed by at least one of the one or more processors, cause at least one of the one or more processors to group the plurality of career path records further cause at least one of the one or more processors to:
determine, for each career path record in the plurality of career path records, whether the career path record corresponds to new career path;
generate a new career path cluster based at least in part on a determination that the career path record corresponds to a new career path, wherein the career path record is added to the new career path cluster; and
add the career path record to an existing career path cluster based at least in part on a determination that the career path record does not correspond to a new career path.

16. At least one non-transitory computer-readable medium storing computer-readable instructions that, when executed by one or more computing devices, cause at least one of the one or more computing devices to:
receive career-related information from a user, the career-related information comprising at least one of a career start point, a career end point, a career start location, and a career end location;
select a plurality of career path records based at least in part on the career-related information received from the user, wherein each of the plurality of career path records includes a plurality of career points comprising a career path;
group the plurality of career path records into a plurality of career path clusters, wherein each career path cluster in the plurality of career path clusters corresponds to a unique career path;
identify a career path cluster in the plurality of career path clusters which contains the greatest number of career path records, the identified career path cluster having a corresponding career path; and
transmit information regarding the corresponding career path.

17. The at least one non-transitory computer-readable medium of claim 16, wherein at least one career path record in the plurality of career path records is generated by:
receiving biographical information from one or more data sources;
identifying a plurality of career points in the biographical information based on an analysis of the biographical information; and
generating a career path record by linking the plurality of career points in chronological order.

18. The at least one non-transitory computer-readable medium of claim 16, wherein the career-related information comprises at least one of the career start point and the career end point and wherein the instructions that, when executed by at least one of the one or more computing devices, cause at least one of the one or more computing devices to select a plurality of career path records further cause at least one of the one or more computing devices to:
identify career path records in a data store which include a career point that is equal to at least one of the career start point and the career end point; and
select the identified career path records.

19. The at least one non-transitory computer-readable medium of claim 16, wherein the career-related information comprises at least one of a career start location and a career end location and wherein the instructions that, when executed by at least one of the one or more processors, cause at least one of the one or more processors to select a plurality of career path records further cause at least one of the one or more processors to:
identify all career path records in a data store which include a career point having an associated career point location which is equal to at least one of the career start location and the career end location; and
select the identified career path records.

20. The at least one non-transitory computer-readable medium of claim 16, wherein the instructions that, when executed by at least one of the one or more processors, cause at least one of the one or more processors to group the plurality of career path records further cause at least one of the one or more processors to:
determine, for each career path record in the plurality of career path records, whether the career path record corresponds to new career path;
generate a new career path cluster based at least in part on a determination that the career path record corresponds to a new career path, wherein the career path record is added to the new career path cluster; and
add the career path record to an existing career path cluster based at least in part on a determination that the career path record does not correspond to a new career path.
